(19) United States
(12) Patent Application Publication
(10) Pub. No.: US 2020/0282809 A1
(43) Pub. Date: Sep. 10, 2020

(54) MOTOR VEHICLE NEBULIZER SYSTEM AND MOTOR VEHICLE COMPRISING SUCH A SYSTEM

(71) Applicant: Valeo Systemes Thermiques, Le Mesnil Saint Denis Cedex (FR)

(72) Inventors: Vincent Feuillard, Le Mesnil Saint Denis Cedex (FR); Stéphane Petit, Le Mesnil Saint Denis Cedex (FR)

(73) Assignee: Valeo Systemes Thermiques, Le Mesnil Saint Denis Cedex (FR)

(21) Appl. No.: 16/759,875

(22) PCT Filed: Oct. 30, 2018
(86) PCT No.: PCT/FR2018/052698

§ 371 Date: Apr. 28, 2020

(30) Foreign Application Priority Data
Oct. 31, 2017 (FR) 1760287

(51) Int. Cl. B60H 3/02; F24F 6/12

(52) U.S. Cl. CPC B60H 3/022; F24F 6/12

(57) ABSTRACT

The nebulizer system (10) for a motor vehicle comprises:—a first reservoir (12) of liquid water,—a second reservoir (14) of liquid water in hydraulic communication with the first reservoir (12), the second reservoir (14) being removably attached to the first reservoir (12), and—a nebulizing nozzle (38), in hydraulic communication with the first reservoir (12) and comprising a piezoelectric element for emitting acoustic waves and a concentrator for the acoustic waves emitted by the piezoelectric element configured such that the water coming from the first reservoir (12) forms a jet (48) of water and a mist (46) of water droplets at the outlet of the concentrator, the mist (46) being intended to leave the nozzle (38) in order to reach a passenger compartment of the vehicle; the second reservoir (14) and the nozzle (38) are arranged, with reference to a vertical direction (Z), above the first reservoir (12) when the system (10) is in the normal use position, so that water coming from the nebulizing nozzle (38) drops into the first reservoir (12).

### FIELD OF THE INVENTION

The invention relates to vehicles and particularly motor vehicles. The invention also relates to the thermal devices of the vehicles. More specifically, the invention relates to the nebulizing systems of these thermal devices.

### TECHNOLOGICAL BACKGROUND OF THE INVENTION

A motor vehicle generally includes one or more thermal devices, particularly for regulating a temperature in a passenger compartment of the motor vehicle. For example, the motor vehicle comprises a ventilation, heating and/or air conditioning device for reducing or increasing the temperature prevailing in the passenger compartment.

The ventilation, heating and/or air conditioning device generally comprises at least one air vent situated on a dashboard of the motor vehicle. This air vent makes it possible to introduce cold air into the passenger compartment when necessary. Passengers in a rear section of the passenger compartment are thus situated at a greater distance from the air vent than passengers in the front section. This is why, when the air vent supplies cold air at a temperature suitable for the passengers in the front section, the passengers in the rear section might feel hot. Conversely, if the air conditioning device supplies colder air to satisfy the passengers in the rear section, the passengers in the front section might be inconvenienced.

In order to regulate the temperature of the passenger compartment and particularly for the passengers in the rear section, nebulizing systems have therefore been installed. Such a system includes a reservoir of liquid water and a nebulizing nozzle that includes a piezoelectric element for emitting acoustic waves and an acoustic wave concentrator. The piezoelectric element vibrates so that it emits an acoustic wave and the concentrator concentrates this wave. The concentrated wave interacts with water coming from the reservoir.

The water thus leaves the nebulizing nozzle in the form of a water droplet mist and a water jet. The droplet mist reaches the vehicle passenger compartment to reduce the temperature of the passenger compartment, particularly in a zone comprising the rear section. The nebulizing nozzle can particularly be arranged close to a zone that comprises tile rear section. Such nebulizing systems also have the advantage of being more environmentally friendly than air conditioning systems.

However, these nebulizing systems are not very user-friendly. They are poorly integrated into the architecture of the motor vehicle. In addition, access to the liquid water reservoir is often complex.

### OBJECT OF THE INVENTION

One aim of the invention is to provide a nebulizing system for a motor vehicle that is more efficiently integrated into the architecture of the vehicle and is easier to use.

### BRIEF DESCRIPTION OF THE INVENTION

To this end, the invention relates to a nebulizing system for a motor vehicle, characterized in that it comprises:
a first reservoir of liquid water,
a second reservoir of liquid water in hydraulic communication with the first reservoir, the second reservoir being removably fixed to the first reservoir, and
a nebulizing nozzle, in hydraulic communication with the first reservoir and including a piezoelectric element for emitting acoustic waves and a concentrator for the acoustic waves emitted by the piezoelectric element configured so that the water coming from the first reservoir forms a water jet and a water droplet mist at the outlet of the concentrator, the mist being capable of leaving the nebulizing nozzle in order to reach a passenger compartment of the motor vehicle,
the second reservoir and the nebulizing nozzle are arranged, with reference to a vertical direction, above the first reservoir when the system is in the normal operating position, so that the water coming from the nebulizing nozzle falls into the first reservoir.

The nebulizing system thus comprises two reservoirs removably fixed to each other. This is why, when a user of the nebulizing system wishes to add liquid water to the system, all that is required is to detach the second reservoir from the first reservoir and fill the second reservoir. According to the invention, the second reservoir can thus advantageously be a bottle with a capacity of 1.5 liters, for example, that the user can fill frequently, which avoids keeping stagnant water for too long. The nebulizing system according to the invention is therefore easier to maintain. In addition, by detaching the second reservoir from the first reservoir, the user can easily access these two reservoirs in order to clean them and particularly to avoid the reservoirs hosting an excessive concentration of bacteria. The nebulizing system according to the invention is therefore safer.

In addition, the nebulizing system according to the invention is more compact. The second reservoir is arranged close to the first reservoir and the nebulizing nozzle is arranged above the first reservoir. The nebulizing system according to the invention thus approximately occupies a parallelepipedal space.

In addition, in various embodiments of the invention, one or more of the following arrangements may also be used:
the second reservoir and the nozzle are arranged, with reference to a vertical direction, on the first reservoir when the system is in the normal operating position;
the second reservoir is arranged above the nebulizing nozzle;
the second reservoir is arranged next to the nebulizing nozzle;
according to the two features mentioned above, the second reservoir is positioned so that it does not encase the nebulizing nozzle;
the second reservoir comprises a liquid water intake that is a liquid water intake for the nebulizing system;
the second reservoir comprises a non-return valve arranged in the liquid water intake so as to enable water from outside the nebulizing system to reach the second reservoir and to prevent the water from the second reservoir from leaving the second reservoir through the liquid water intake; the reliability of the nebulizing system is improved;
the nebulizing system comprises a non-return valve arranged between the first reservoir and the second reservoir so as to enable the water to circulate from the second reservoir to the first reservoir but prevent the water from circulating from the first reservoir to the second reservoir; similarly, the reliability of the nebulizing system is thus improved;
the non-return valve can particularly be replaced by a valve;
the valve can be manually or electrically controlled;
the nebulizing system includes a conveying duct configured to direct the water droplet mist leaving the nozzle toward the passenger compartment of the motor vehicle;
the conveying duct contains the nebulizing nozzle; the nebulizing nozzle is thus protected;
the conveying duct comprises two cylindrical portions arranged one after the other and forming an acute angle between them;
the conveying duct comprises two cylindrical portions arranged one after the other and forming an obtuse angle between them;
the nebulizing system includes a fan in air communication with the conveying duct and configured to discharge into the conveying duct a stream of air in a direction of discharge of the water droplet mist toward the passenger compartment of the motor vehicle; the fan makes it possible to direct the droplet mist reliably;
the conveying duct contains the fan; the fan is thus protected by the conveying duct;
the nebulizing system includes means for directing the water jet coming from the concentrator to the first reservoir; the water jet is thus recovered;
the nebulizing system includes a pump arranged between the first reservoir and the nebulizing nozzle;
the nebulizing system includes a water filter arranged between the first reservoir and the nebulizing nozzle;
the first reservoir is substantially parallelepipedal;
the second reservoir is substantially cylindrical;
the conveying duct is substantially cylindrical.

A ventilation, heating and/or air conditioning device for a motor vehicle is also envisaged according to the invention, comprising a nebulizing system as described above.

A vehicle passenger compartment comprising a device as mentioned above is also envisaged according to the invention.

### BRIEF DESCRIPTION OF THE DRAWINGS

An embodiment of the invention will now be described by way of non-limitative example, with reference to the following figures:

FIG. 1 diagrammatically illustrates a nebulizing system according to the invention, seen from the side,

FIG. 2 diagrammatically shows the nebulizing system when it is not actuated and in which a conveying duct and a fan of the nebulizing system are not shown, and

FIG. 3 is a similar view to FIG. 2, when the nebulizing system is actuated.

### DETAILED DESCRIPTION OF AN EMBODIMENT OF THE INVENTION

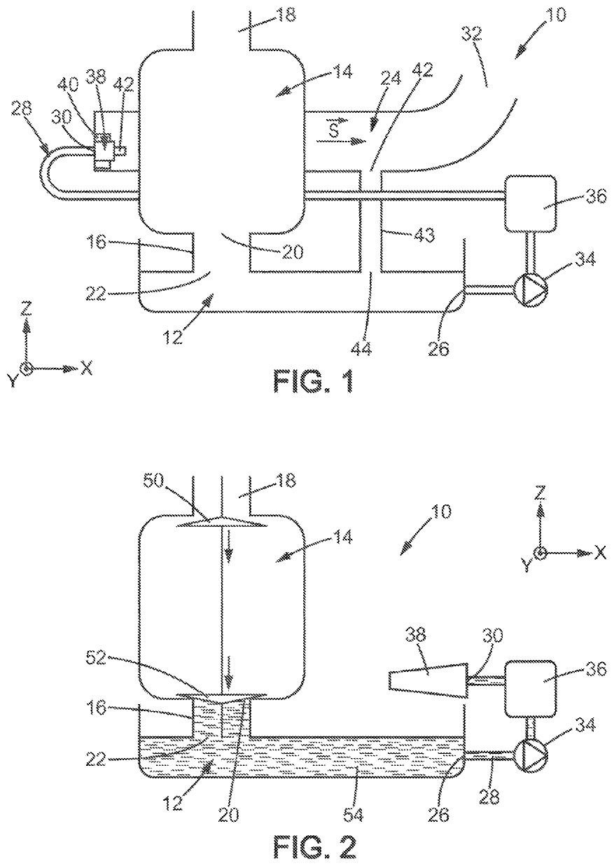

FIG. 1 shows a nebulizing system 10 according to one embodiment of the invention. The nebulizing system 10 forms part of a thermal device of a motor vehicle passenger compartment capable of reducing the temperature prevailing in the passenger compartment and more specifically in a zone that comprises a rear section of the passenger compartment. It will be noted that according to the invention, the nebulizing system can be capable of reducing the temperature of any zone of the passenger compartment and particularly of the entire passenger compartment itself. It will also be noted that according to the invention, the thermal device comprising the nebulizing system 10 can be arranged in any type of vehicle.

As illustrated in FIG. 1, the nebulizing system 10 includes a first reservoir 12 and a second reservoir 14. The first reservoir 12 and the second reservoir 14 are in hydraulic communication by means of a pipe 16. The second reservoir 14 thus includes a liquid water intake 18 that also forms a liquid water intake 18 for the nebulizing system 10. The second reservoir 14 also includes a liquid water outlet 20 in hydraulic communication, by means of the pipe 16, with a liquid water intake 22 of the first reservoir 12.

In addition, the nebulizing system 10 comprises a conveying duct 24 in hydraulic communication with the first reservoir 12, by means of a first pipe 28. The first reservoir 12 thus includes a liquid water outlet 26 in hydraulic communication, by means of the first pipe 28, with a liquid water intake 30 of the conveying duct 24.

The conveying duct 24 also includes a water droplet mist and air outlet 32, as will be explained below, which emerges into the zone of the passenger compartment that comprises the rear section. The outlet 32 can particularly emerge into a console of the passenger compartment arranged between a driver's seat and a front passenger seat and be oriented toward the zone that comprises the rear section.

In addition, the conveying duct 24 contains a nebulizing nozzle 38 and a fan 40. The nebulizing nozzle 38 is arranged directly on the liquid water intake 30 of the conveying duct 24. The nebulizing nozzle 38 is thus in hydraulic communication with the first reservoir 12 by means of the first pipe 28.

The nebulizing nozzle 38 comprises a liquid water outlet 42 into the conveying duct 24. The fan 40 is suitable for discharging a stream of air S, illustrated in FIG. 1, into the conveying duct 24 in a direction that goes from the liquid water intake 30 of the conveying duct 24 toward the water droplet mist and air outlet 32 of the conveying pipe 24.

It will be noted that according to one variant of the present embodiment, the conveying duct 24 does not contain the fan 40, but the latter is in air communication, for example by means of a specific pipe, with the conveying duct 24.

Furthermore, the conveying duct 24 is in hydraulic communication with the first reservoir 12 by means of a second pipe 43. The conveying duct 24 thus includes a second liquid water outlet 42 in hydraulic communication with a second intake 44 of the first reservoir 12. The function of the second pipe 40 will be described below. The second intake 44 and the second pipe 43 make it possible to return liquid water to the first reservoir 12. In other words, the second intake 44 and the second pipe 43 make it possible to recirculate liquid water that is not nebulized.

In addition, the first pipe 28 comprises a hydraulic pump 34 and a water filter 36. The hydraulic pump 34 and the water filter 36 are thus arranged between the first reservoir 12 and the nebulizing nozzle 38. The hydraulic pump 34 has the function of circulating water from the first reservoir 12, in the first pipe 28, to the nebulizing nozzle 38 situated in the conveying duct 24. The water filter 36 has the function of filtering the water that circulates in the first pipe 28.

In addition, the nebulizing nozzle 38 includes, in a manner known per se, a piezoelectric element for emitting acoustic waves and a concentrator for the acoustic waves emitted by the piezoelectric element, not shown. The piezoelectric element can particularly be a quartz crystal. The piezoelectric element vibrates when it is supplied with electricity. The acoustic wave concentrator can take the form of an enclosure that has a convergent shape from a liquid water intake to a liquid water outlet so that it focuses, in the water jet, the acoustic waves emitted by the piezoelectric element in order to improve the water droplet mist output.

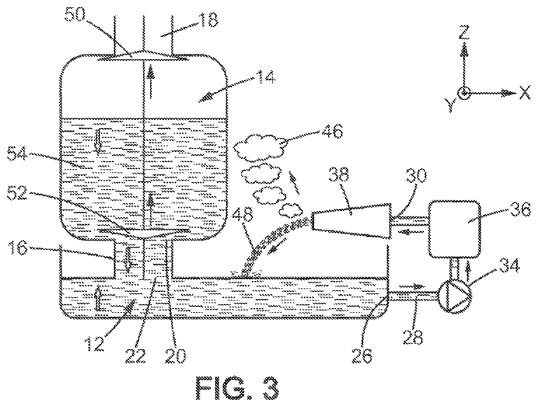

As diagrammatically shown in FIG. 3, the acoustic wave concentrator is thus configured so that liquid water coming from the first reservoir 12 forms, at the outlet of the concentrator and when the piezoelectric element is actuated, a water droplet mist 46 and a water jet 48. As a result, the water droplet mist 46 and the water jet 48 are discharged into the conveying duct 24. The water droplet mist 46 is then directed, by means of the stream of air S, toward the outlet 32 of the conveying duct 24 and therefore toward the passenger compartment of the motor vehicle. The conveying duct 24 is thus configured to direct the water droplet mist 46 leaving the nebulizing nozzle 38 toward the passenger compartment of the motor vehicle. The fan 40 is therefore also configured to discharge the stream of air S in a direction of discharge of the water droplet mist 46 toward the passenger compartment of the motor vehicle.

It will also be noted that the water droplets 46 have a diameter that depends on the vibration frequency of the piezoelectric element. For example, the diameter of the droplets 46 is less than 10 μm. The water jet 48 also flows in the conveying duct 24, then reaches the first reservoir 12, under the effect of gravity, by means of the second pipe 43. Thus, at least the second pipe 43 forms means for directing the water jet 48 coming from the concentrator toward the first reservoir 12.

In addition, as diagrammatically illustrated in FIGS. 2 and 3, the liquid water intake 18 of the second reservoir 14 includes a non-return valve 50 configured so that liquid water from outside the second reservoir 14 and therefore from outside the nebulizing system 10 can reach the second reservoir 14 but so that liquid water in the second reservoir 14 cannot leave the second reservoir 14 through the liquid water intake 18.

Similarly, the liquid water outlet 20 of the second reservoir 14 includes a non-return valve 52 configured to allow liquid water to circulate from the second reservoir 14 to the first reservoir 12 but to prevent the liquid water from circulating from the first reservoir 12 to the second reservoir 14. In addition, the non-return valve 52 only lets the water pass from the second reservoir 14 to the first reservoir 12 when it is electrically actuated, as will be described below.

It will be noted that according to variants of the present embodiment, the non-return valves 50 and 52 are replaced by electrically-controlled valves. Similarly, the liquid water intake 18 of the second reservoir 14 can include a plug that is removably fixed to the second reservoir 14 for example by means of a screw/nut connection.

In addition, the nebulizing system 10 includes an electronic control module that particularly controls the non-return valves 50, 52, the hydraulic pump 34, the fan 40 and the piezoelectric element of the nebulizing nozzle 38. This electronic control module can be automated or be controlled by an electronic system of the motor vehicle.

The arrangement of the different parts of the nebulizing system 10 in relation to each other will now be described.

Advantageously, the first reservoir 12 is substantially parallelepipedal, and extends mainly in a horizontal plane XY, when the nebulizing system 10 is in a normal operating position. In addition, the second reservoir 14 is cylindrical and extends longitudinally in a vertical direction Z. The conveying duct 24 is also cylindrical and extends longitudinally in a horizontal direction X. The conveying duct 24 can advantageously comprise two cylindrical portions arranged one after the other and forming between them an acute or obtuse angle in order to give the conveying duct 24 a generally upwardly bent shape, with reference to the vertical direction Z, in order to prevent excessively large drops of water reaching the passenger compartment of the vehicle.

In addition, as particularly illustrated in FIG. 1, with reference to the vertical direction Z, tile second reservoir 14 and the conveying duct 24, which contains the nebulizing nozzle 38, are arranged above the first reservoir 12. In addition, it will be noted that the second reservoir 14 is removably fixed to the first reservoir 12, for example by means of a screwed connection. A user of the nebulizing system 10 can thus easily access the second reservoir 14 and the first reservoir 12 in order to clean it. In addition, when, according to one variant of the present embodiment, the second reservoir 14 does not comprise the liquid water intake 18, the user can fill the second reservoir 14 by means of the liquid water outlet 20.

The operation of the nebulizing system 10 will now be described, particularly with reference to FIGS. 2 and 3.

At least the first reservoir 12 contains a body of water 54.

When the electronic control module actuates the nebulizing system 10, the hydraulic pump 34 is activated so that, if necessary, it conveys water from the first reservoir 12 to the nebulizing nozzle 38, after filtering by the water filter 36, by means of the pipe 28.

Then, the piezoelectric element is actuated so that it produces an acoustic wave. This acoustic wave is concentrated by the acoustic concentrator in the nebulizing nozzle 38 so that it generates the water droplet mist 46 and the water jet 48 at the outlet of the nebulizing nozzle 38. This water droplet mist 46 and this water jet 48 are thus discharged into the conveying duct 24.

Simultaneously, the electronic control module actuates the fan 40 so that it generates the stream of air S that directs the water droplet mist 46 into the conveying duct 24 to the outlet 32 of the conveying duct 24 so that the water droplet mist 46 reaches the zone of the passenger compartment that comprises the rear section.

In parallel, the stream of air S directs the water jet 48 toward the second pipe 43 so that the water jet 48 reaches the first reservoir 12. The first reservoir 12, which is fixed relative to the nebulizing nozzle 38, thus has the function of forming a tank for recovering the water jet coming from the nebulizing nozzle 38. It also forms a “buffer reservoir” for the loop for recirculating the water coming from the nebulizing nozzle 38. The first reservoir 12 is thus situated below the nebulizing nozzle 38, with reference to the vertical direction Z so that the water jet coming from the nebulizing nozzle 38 falls into the first reservoir 12. The first reservoir 12 can therefore have a minimal capacity and thus have a smaller footprint. For example, its capacity is less than 0.5 l.

In addition, in a particular embodiment, when the first reservoir 12 no longer contains sufficient water for the nebulizing system 10 to operate, the electronic control module can activate the non-return valve 52 so that water circulates, by means of the pipe 16, from the second reservoir 14 to the first reservoir 12.

The second reservoir 14 is removable relative to the first reservoir 12, as explained previously. In addition, the second reservoir 14 has a larger capacity and makes it possible to supply the first reservoir 12. It can particularly have a capacity greater than 0.5 l. In addition, in this embodiment, the second reservoir 14 and the nebulizing nozzle 38 are arranged on the same level, in the vertical direction Z. According to another variant, the second reservoir 14 is arranged on the nebulizing nozzle 38. Generally, the second reservoir 14 is arranged relative to the nebulizing nozzle 38 so that the latter is not encased by the second reservoir 14.

Of course, numerous modifications can be made to the invention without departing from the scope thereof.

The nebulizing nozzle 38 can comprise any type of acoustic wave emitting device instead of or in addition to the piezoelectric element.

The nebulizing system 10 may not comprise the conveying duct 24. In this case, at the concentrator outlet, the water droplet mist 46 and the water jet 48 leave the nebulizing nozzle 38 and directly reach the passenger compartment of the motor vehicle.

The second pipe 43 can include a hydraulic pump.

The second reservoir 14 can have any type of shape in order to occupy a space left free by the nebulizing nozzle 38.

One embodiment not described proposes that the second reservoir be made in a removable form, for example, that of a bottle of mineral water.

Another embodiment not described proposes that a valve system (for example spring-controlled) be secured to the second reservoir.

1. A nebulizing system for a motor vehicle, comprising:
a first reservoir of liquid water;
a second reservoir of liquid water in hydraulic communication with the first reservoir, the second reservoir being removably fixed to the first reservoir; and
a nebulizing nozzle, in hydraulic communication with the first reservoir and including a piezoelectric element for emitting acoustic waves and a concentrator for the acoustic waves emitted by the piezoelectric element configured so that the water coming from the first reservoir forms a water jet and a water droplet mist at the outlet of the concentrator, the mist being capable of leaving the nebulizing nozzle in order to reach a passenger compartment of the motor vehicle,
wherein the second reservoir and the nebulizing nozzle are arranged, with reference to a vertical direction, above the first reservoir when the system is in the normal operating position, so that the water coming from the nebulizing nozzle falls into the first reservoir.

2. The nebulizing system as claimed in claim 1, in which the second reservoir is arranged above the nebulizing nozzle with reference to the vertical direction.

3. The nebulizing system as claimed in claim 2, in which the second reservoir includes a liquid water intake that is a liquid water intake for the nebulizing system.

4. The nebulizing system as claimed in claim 3, in which the second reservoir comprises a non-return valve arranged in the liquid water intake so as to enable water from outside the nebulizing system to reach the second reservoir and to prevent the water from the second reservoir from leaving the second reservoir through the liquid water intake.

5. The nebulizing system as claimed in claim 1, further comprising a non-return valve arranged between the first reservoir and the second reservoir so as to enable the water to circulate from the second reservoir to the first reservoir but prevent the water from circulating from the first reservoir to the second reservoir.

6. The nebulizing system as claimed in claim 1, further comprising a conveying duct configured to direct the water droplet mist leaving the nozzle toward the passenger compartment of the motor vehicle.

7. The nebulizing system as claimed in claim 6, further comprising a fan in air communication with the conveying duct and configured to discharge into the conveying duct a stream of air in a direction of discharge of the water droplet mist toward the passenger compartment of the motor vehicle.

8. The nebulizing system as claimed in claim 1, further comprising means for directing the water jet coming from the concentrator toward the first reservoir.

9. The nebulizing system as claimed in claim 1, including a water filter (36) arranged between the first reservoir (12) and the nebulizing nozzle (38).

10. A ventilation, heating and/or air conditioning device for a motor vehicle, comprising:
a nebulizing system comprising
a first reservoir of liquid water,
a second reservoir of liquid water in hydraulic communication with the first reservoir, the second reservoir being removably fixed to the first reservoir, and
a nebulizing nozzle, in hydraulic communication with the first reservoir and including a piezoelectric element for emitting acoustic waves and a concentrator for the acoustic waves emitted by the piezoelectric element configured so that the water coming from the first reservoir forms a water jet and a water droplet mist at the outlet of the concentrator, the mist leaving the nebulizing nozzle to reach a passenger compartment of the motor vehicle,
wherein the second reservoir and the nebulizing nozzle are arranged, with reference to a vertical direction, above the first reservoir when the nebulizing system is in the normal operating position, so that the water coming from the nebulizing nozzle falls into the first reservoir.

11. A nebulizing system for a motor vehicle comprising:
a first reservoir of liquid water,
a second reservoir of liquid water in hydraulic communication with the first reservoir, the second reservoir being removably fixed to the first reservoir, and
a nebulizing nozzle, in hydraulic communication with the first reservoir and including a piezoelectric element for emitting acoustic waves and a concentrator for the acoustic waves emitted by the piezoelectric element configured so that the water coming from the first reservoir forms a water jet and a water droplet mist at the outlet of the concentrator, the mist leaving the nebulizing nozzle to reach a passenger compartment of the motor vehicle,
wherein the second reservoir is arranged close to the first reservoir and the nebulizing nozzle is arranged above the first reservoir, the nebulizing system thereby occupying a parallelepipedal space, and
wherein water is added to the nebulizing system by detachment of the removably fitted second reservoir from the first reservoir.
